(19) United States
(12) Patent Application Publication
(10) Pub. No.: US 2018/0268371 A1
(43) Pub. Date: Sep. 20, 2018

(54) Branch-And-Price-And-Check Model For The Vehicle Routing Problem With Location Resource Constraints

(71) Applicant: The Regents of The University of Michigan, Ann Arbor, MI (US)

(72) Inventors: Pascal VAN HENTENRYCK, Ann Arbor, MI (US); Edward LAM, Sydney (AU)

(21) Appl. No.: 15/920,971

(22) Filed: Mar. 14, 2018

Related U.S. Application Data
(60) Provisional application No. 62/470,923, filed on Mar. 14, 2017.

(51) Int. Cl. G06Q 10/08; G06Q 10/04; G06Q 10/06

(52) U.S. Cl. CPC G06Q 10/08355; G06Q 10/06315; G06Q 10/047

(57) ABSTRACT

This disclosure considers a vehicle routing problem with pickup and delivery, time windows, and location resource constraints. Locations provide a number of cumulative resources that are utilized by vehicles either during service (e.g., forklifts) or for the entirety of their visit (e.g., parking bays). The problem is highly challenging from a computational standpoint as the resource constraints add temporal dependencies between vehicles and a scheduling substructure not featured in traditional vehicle routing problems. The main contribution of this disclosure is a branch-and-price-and-check model that incorporates a branch-and-price algorithm that solves the underlying vehicle routing problem, and a constraint programming subproblem that checks the feasibility of the location resource constraints, and then adds combinatorial nogood cuts to the master problem if the resource constraints are violated.

### CROSS-REFERENCE TO RELATED APPLICATIONS

This application claims the benefit of U.S. Provisional Application No. 62/470,923, filed on Mar. 14, 2017. The entire disclosure of the above application is incorporated herein by reference.

### FIELD

The present disclosure relates to a branch-and-price-and-check model for the vehicle routing problem with location resource constraints.

### BACKGROUND

A Vehicle Routing Problem (VRP) is a combinatorial optimization problem that aims to construct routes for a fleet of vehicles that service customer requests while minimizing some cost function. The family of VRPs is extensive and includes variants that specify additional side constraints, such as time window constraints that restrict the time at which service of a request can commence, and precedence constraints that require one request to be served before another.

This disclosure explores a rich variant named the Vehicle Routing Problem with Pickup and Delivery, Time Windows, and Location Resource Constraints (VRPPDTWLRC, or VRPLRC for short). This problem is based on the regular VRP with Pickup and Delivery, and Time Windows (VRPPDTW), but overlays cumulative resource constraints that limit the number of vehicles present and/or in service at a location at any given time. Examples of resources may include parking bays for the first case, and forklifts for the second case. If all resources at a location are in use, incoming vehicles cannot proceed but must wait until a resource becomes available. This results in temporal dependencies between vehicles, which do not exist in traditional VRPs. In particular, a delay on one route may entail a delay on another route if both routes visit a common location.

This disclosure studies a constraint programming model and a branch-and-price-and-check (BPC) model for the VRPLRC. The BPC approach, inspired by a branch-and-cut-and-price method for the VRPPDTW, combines a branch-and-price algorithm that solves the VRPPDTW, and a constraint programming subproblem that lifts the VRPPDTW to a VRPLRC by checking VRPPDTW solutions against the location resource constraints. If these constraints are violated, a combinatorial Benders cut (or nogood cut) is added to the master problem to forbid this infeasible VRPPDTW solution. To our knowledge, this is the first model that integrates branch-and-price and branch-and-check.

The two models are evaluated on instances with up to 300 requests (150 pickup and delivery requests) and both types of location resources. Results indicate that the BPC algorithm scales better than the pure constraint programming model, optimally solves instances with 160 visits in under 10 minutes, and finds high-quality solutions for larger problems. The BPC model nicely exploits most of the strengths of the constraint programming (CP) and branch-and-cut-and-price approaches. Note, however, that the CP model can prove infeasibility on instances with service requests when the resource capacity is one.

This section provides background information related to the present disclosure which is not necessarily prior art.

### DRAWINGS

The drawings described herein are for illustrative purposes only of selected embodiments and not all possible implementations, and are not intended to limit the scope of the present disclosure.

FIG. 1 is table showing the Constraint Programming Model.

FIG. 2 is a table showing the Master Problem of the Branch-and-Price-and Check Formulation.

FIG. 3 is a table showing the Constraints of the Separation Subproblem for Service Resources.

FIG. 4 is a table showing the Constraints of the Separation Subproblem for Presence Resources.

FIG. 5 is a flowchart depicting an example method for determining vehicle routing with location resource constraints.

FIG. 6 is a block diagram of an example vehicle routing system.

### DETAILED DESCRIPTION

Example embodiments will now be described more fully with reference to the accompanying drawings.

Vehicle routing problems are studied extensively in the literature and can be solved using a range of methods. A standard formulation is a flow-based mixed integer programming (MIP) model that uses big-M rewritings to model logical constraints. Since the linear relaxation of this model is typically weak, it cannot scale to larger instances. This issue is mitigated in branch-and-cut approaches, which periodically solve a separation subproblem during search to generate valid inequalities that strengthen this formulation. The VRPLRC problem augments a regular VRP with Pickups and Deliveries, and Time Windows (VRPPDTW) with two major additions: the explicit modeling of locations and the location resource constraints.

In traditional VRPs, requests and locations are synonymous; each request is assumed to have its own location, even if it overlaps another location. In the VRPLRC, requests are grouped by location, which cannot overlap. Distance costs and travel times are defined between locations. Moreover, every location features a number of cumulative resources, with a fixed capacity that cannot be exceeded at any given time. Two types of resources are considered: a service resource is used while a request is in service, and a presence resource is used by a vehicle from the moment it arrives at a location until it departs from the location. Service resources are fully encompassed by presence resources, since the start of a visit is necessarily before the start of service, and the end of a visit after the end of service. Even though the problem studied within this disclosure only considers one of these two types of resources, the formulation naturally generalizes to multiple copies of these types of resources.

Contrary to traditional VRPs, delaying a route in a VRPLRC may affect the feasibility of other routes since, for example, a delayed vehicle may postpone the availability of a resource required by another vehicle. The delay incurred by the second vehicle may induce, for instance, a time window violation on this second route. These temporal interactions between vehicles require reasoning about the timing and scheduling of the vehicle visits, and makes VRPLRCs more challenging to solve than their more traditional counterparts.

A constraint programing model is first presented for the VRPLRC. The model is based on the standard constraint programming model of VRPs using successor variables, but explicitly models locations and location resources. Table 1 below lists the data and decision variables in the model.

| Name | Description |
|---|---|
| T ∈ {1, . . . , ∞} | Time horizon. |
| [symbol] = {0, . . . , T} | Set of time values. |
| V ∈ {1, . . . , ∞} | Number of vehicles. |
| [symbol] = {1, . . . , V} | Set of vehicles. |
| Q ∈ {0, . . . , ∞} | Vehicle capacity. |
| P ∈ {1, . . . , ∞} | Total number of pickup-delivery pairs. |
| R = 2P | Total number of requests. |
| [symbol] = {1, . . . , P} | Set of pickup requests/nodes. |
| [symbol] = {P + 1, . . . , R} | Set of delivery requests/nodes. |
| [symbol] = [symbol] ∪ [symbol] | Set of all requests. |
| S = {R + 1, . . . , R + V} | Set of vehicle start nodes. |
| ε = {R + V + 1, . . . , | Set of vehicle end nodes. |
| R + 2V} | |
| s(v) = R + v | Start node of vehicle v ∈ [symbol] . |
| e(v) = R + V + v | End node of vehicle v ∈ [symbol] . |
| [symbol] = [symbol] ∪ S ∪ ε | Set of all requests and vehicle start and end |
| | nodes. |
| L ∈ {1, . . . , ∞} | Number of locations, excluding the depot |
| | location. |
| [symbol] = {1, . . . , L} | Set of locations, excluding the depot location. |
| Cₗ ∈ {1, . . . , ∞} | Capacity of the resource at location l ∈ [symbol] . |
| l(i) ∈ [symbol] | Location of i ∈ [symbol] . |
| [symbol] ᵢ = {i ∈ [symbol] : l(i) = l} | Requests at location l ∈ [symbol] . |
| d(i, j) ∈ [symbol] | Distance and travel time from i ∈ [symbol] to j ∈ [symbol] . |
| a(i) ∈ [symbol] | Earliest start of service at i ∈ [symbol] . |
| b(i) ∈ [symbol] | Latest start of service at i ∈ [symbol] . |
| t(i) ∈ [symbol] | Service duration of i ∈ [symbol] . |
| q(i) ∈ {−Q, . . . , Q} | Demand at i ∈ [symbol] . |
| succ(i) ∈ [symbol] | Successor node of i ∈ [symbol] . |
| veh(i) ∈ [symbol] | Vehicle that visits i ∈ [symbol] . |
| arr(i) ∈ [symbol] | Arrival time at i ∈ [symbol] . |
| serv(i) ∈ {a(i), . . . , | Start of service at i ∈ [symbol] . |
| b(i)} | |
| dep(i) ∈ [symbol] | Departure time at i ∈ [symbol] . |
| dur(i) ∈ [symbol] | Visit duration at i ∈ [symbol] . |
| load(i) ∈ {0, . . . , Q} | Load of vehicle veh(i) after servicing i ∈ [symbol] . |

Note the inputs Rₗ and Cₗ that, respectively, represent the set of requests and the capacity of the resource at location l. The primary decision variables are the successor variables, which determine the route of each vehicle. The secondary decision variables are the arrival, service, and departure times. It is understood that variants of the model may include other types of data and decision variables.

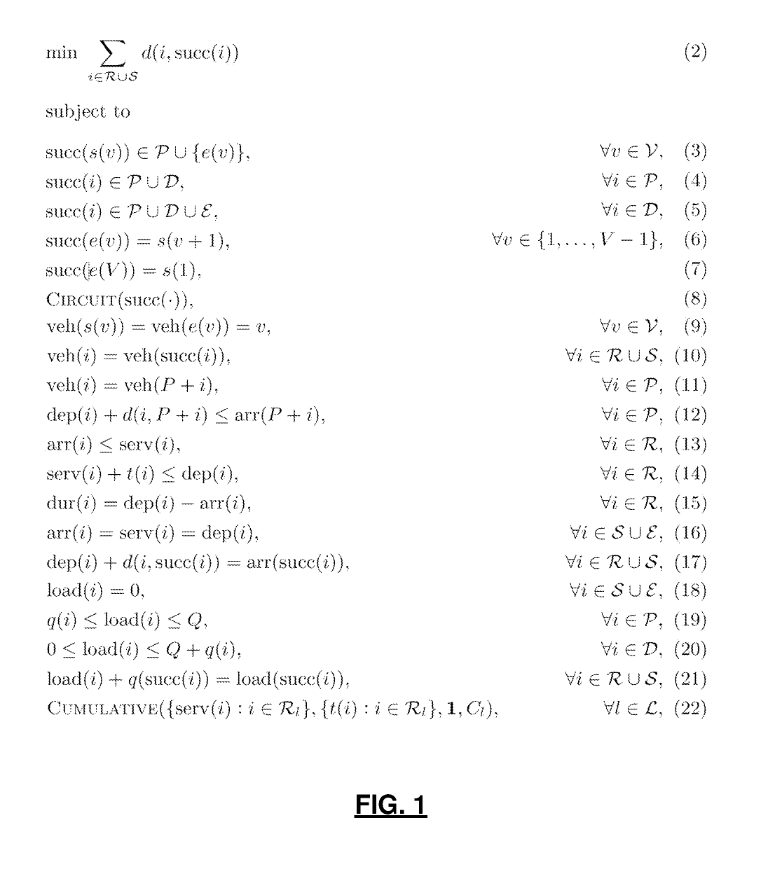

FIG. 1 depicts an example constraint programming model. The objective function (2) minimizes the cost of the routes. Constraints 3-5 are the domain restrictions that ensure the requests along a route are correctly ordered. Constraints 6-7 link the end of a route to the start of the next route, which enables the CIRCUIT global constraint to eliminate subtours (Constraint 8). Constraints 9-10 track the requests visited by each vehicle. Constraints 11-12 are the pickup and delivery constraints. Constraints 13-14 order the arrival, service and departure times at each request, and Constraint 15 calculates the duration of each visit. Constraint 16 enforces a common arrival/departure time at the start and end depot nodes. Constraint 17 implements travel times. Constraints 18-21 are the usual load constraints.

Constraint 22 models the service resources. For presence resources, it can be replaced by

CUMULATIVE({arr(i):i∈ [symbol] ₗ}{dur(i)∈ [symbol] ₗ},1,Cₗ),∀l∈ [symbol] (1)

The constraints are modeled using the CUMULATIVE (s, d, r, C) global constraint, where s, d, and r are vectors that, respectively, represent the start, time, duration, and resource requirement of each activity, and C is the capacity of the resource. It is important to note that the service durations are fixed by the instance data, whereas the presence durations are variables.

Next, the branch-and-price-and-check (BPC) approach to the VRPLRC problem is described. The BPC algorithm builds upon the ideas of the branch-and-cut-and-price model of the VRPPDTW, which employs column generation to produce routes, and a separation subproblem to generate valid inequalities that forbid certain classes of infeasible routes. Although column generation itself can solve the problem, the cuts add problem-specific knowledge and greatly improve convergence. In other words, these cuts are implied cuts since they are not necessary to correctly formulate the problem.

The BPC model follows a similar approach; the difference is that the cuts generated by the separation subproblem enforce the location resource constraints. These cuts are not implied cuts since they are necessary to solve the problem correctly, and they do not appear elsewhere in the problem. In that sense, BPC is related to Benders decomposition with the difference that the subproblem is solved at each node of the branch-and-price tree. This disclosure presents the first model that integrates branch-and-price and branch-and-check.

Referring to FIG. 2, the master problem is the linear relaxation of a set partitioning problem. It selects a subset of routes from a main pool Ω of routes such that this subset satisfies certain constraints. The variable xᵣ denotes whether route r∈Ω is selected. The total cost of the subset is minimized by the objective function (23), where cᵣ is the cost of route r.

Constraint (24) ensures that all pickup requests are visited. The coefficient aᵢᵣ is equal to 1 if route r visits request i∈ [symbol] and equal to 0 otherwise. For column generation models of VRPs, the request cover constraints are usually written as inequalities, rather than strict equalities, because the linear relaxation of the set covering problem with inequalities is easier to solve than the set partitioning problem. For the VRPLRC, the cover constraints are expressed as equalities because of the location resource constraints. Indeed, covering a request multiple times would artificially inflate the number of resources required, which should be avoided. An alternative approach would be to send only one of these requests to the separation subproblem but this would introduce some random choices in the communication between the master and the subproblem. Constraint (25) imposes the nogood cuts. A nogood cut has an associated set B of arcs, and coefficient Bᵣ that denotes the number of arcs in B that are traversed by route r. When a set of routes is determined to be infeasible by the separation subproblem, one nogood cut is added to the master problem, with B containing the arcs traversed by the routes in this set. Hence, the nogood cut prohibits this set of routes by allowing at most |B|−1 of their arcs to be used in any feasible solution.

The pricing subproblem generates routes to add to Ω by solving an elementary resource-constrained shortest path problem using a labeling algorithm; e.g., see the article “The pickup and delivery problem with time windows” by Y. Dumas et al., European Journal of Operational Research 54(1), 7-22 (1991)); as well as “Branch and cut and price for the pickup and delivery problem with time windows” by S. Ropke et al., Transportation Science 43(3), pp. 267-286 (2009) which are incorporated in their entirety. Let [symbol] be the set of pickups, and N be the set of all nodes, which consists of the pickups, deliveries, one start node, and one end node. Let dᵢⱼ be the distance cost from i∈ [symbol] to ∈ [symbol] . The subproblem generates routes that:
1. leave the start node, visit a number of requests, and return to the end node;
2. satisfy the service start time window, travel time, load, and pickup-delivery constraints; and
3. has negative cost with respect to the transformed reduced cost matrix \hat{d}ᵢⱼ.
   To define the transformed reduced cost matrix, first define the reduced cost matrix

$${\overline{d}}_{ij} = \{ \begin{matrix}{d}_{ij} - {π}_{i} + {\sum }_{B ∈ B} 1 {B}_{ij} {μ}_{B} , & \text{∀} i ∈ 𝒫 , j ∈ 𝒩 , \\ {d}_{ij} + {\sum }_{B ∈ B} 1 {B}_{ij} {μ}_{B} , & \text{∀} i ∈ 𝒩 \backslash 𝒫 , j ∈ 𝒩 ,\end{matrix} \qquad ( 27 )$$

where πᵢ is the dual value of Eq. (24), μ_{B} is the dual of Eq. (25), and 1_{Bij} is equal to 1 if the arc (i,j) appears in B∈B and 0 otherwise.

Like the branch-and-cut-and-price model of the VRPPDTW, the transformed reduced cost matrix \hat{d}ᵢⱼ is created by modifying the reduced cost matrix d̅ᵢⱼ to respect the delivery triangle inequality which allows for a stronger dominance criterion. The transformation process is discussed in “Branch and Cut and Price for the Pickup and Delivery Problem with Time Windows” by S. Ropke et al., Transportation Science 43(3), pp. 267-286 (2009) which is incorporated in its entirety.

The labeling algorithm begins with a label at the start node. This label represents a subpath consisting of only the start node. The label is extended to each pickup node in turn, giving subpaths consisting of the start node and one pickup node. Provided that these subpaths are feasible with respect to the constraints mentioned above, their corresponding labels are extended to other nodes. This process is repeated until a number of subpaths reach the end node, or an early termination criteria stops the pricing subproblem.

Next, the separation subproblem for both service and presence resource constraints is described. The subproblem is modeled as a constraint program and contains similar constraints to those in the constraint programming model. While reference is made to two particular resource constraints, other types of resource constraints also fall within the scope of this disclosure.

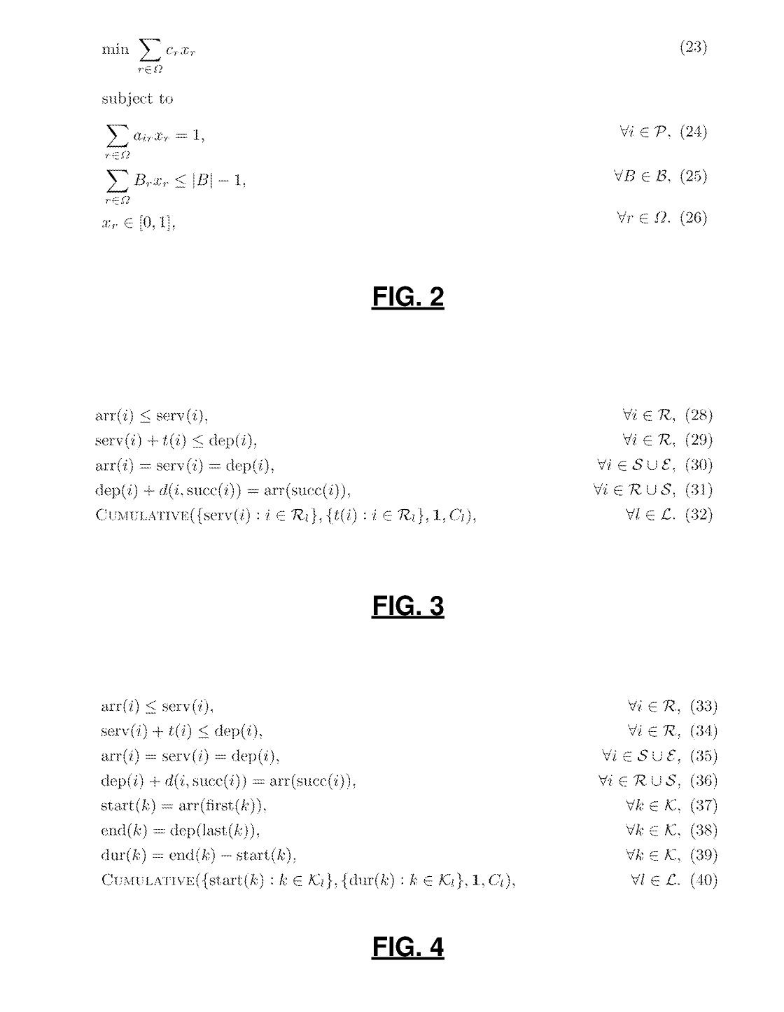

For the case of service resources, the constraints in the separation subproblem are extracted from the time and scheduling constraints of the CP model of the VRPLRC. Table 2 below lists the data and decision variables. The number V of vehicles and the successor variables succ(·) are not decision variables; they are fixed by the routes chosen by the master problem. FIG. 3 lists the constraints of the separation subproblem for service resources. The decision variables are the arrival, service and departure times. Constraints (28-31) are the time constraints and serve as activity precedence constraints for the scheduling constraint (32).

TABLE 2
Data and Decision Variables in the
Separation Subproblem For Service Resources

| Name | Description |
|---|---|
| T ∈ {1, . . . , ∞} | Time horizon. |
| [symbol] = {0, . . . , T} | Set of time values. |
| V ∈ {1, . . . , ∞} | Number of vehicles. |
| R ∈ {1, . . . , ∞} | Total number of requests. |
| [symbol] = {1, . . . , R} | Set of all requests. |
| S = {R + 1, . . . , R + V} | Set of vehicle start nodes. |
| ε = {R + V + 1, . . . , | Set of vehicle end nodes. |
| R + 2V} | |
| [symbol] = [symbol] ∪ S ∪ ε | Set of all nodes. |
| L ∈ {1, . . . , ∞} | Number of locations, excluding the depot |
| | location. |
| [symbol] = {1, . . . , L} | Set of locations, excluding the depot location. |
| Cₗ ∈ {1, . . . , ∞} | Number of resources available at location |
| | l ∈ [symbol] . |
| l(i) ∈ [symbol] | Location of i ∈ [symbol] . |
| [symbol] ᵢ = {i ∈ [symbol] : l(i) = l} | Requests at location l ∈ [symbol] . |
| d(i, j) ∈ [symbol] | Distance and travel time from i ∈ [symbol] to j ∈ [symbol] . |
| a(i) ∈ [symbol] | Earliest start of service at i ∈ [symbol] . |
| b(i) ∈ [symbol] | Latest start of service at i ∈ [symbol] . |
| t(i) ∈ [symbol] | Service duration of i ∈ [symbol] , |
| succ(i) ∈ [symbol] ∪ ε | Successor node of i ∈ [symbol] ∪ S as per the routes |
| | in the master problem. |
| arr(i) ∈ [symbol] | Arrival time at i ∈ [symbol] , |
| serv(i) ∈ {aᵢ, . . . , bᵢ} | Start of service at i ∈ [symbol] , |
| dep(i) ∈ [symbol] | Departure time at i ∈ [symbol] , |

Consider now the separation subproblem for presence resources. Although it is possible to implement Constraint (1) in this subproblem, it is more effective to preprocess the routes from the master program and introduce the concept of a location visit to reduce the number of activities in the subproblem. A location visit starts when a vehicle arrives at a location and lasts until the vehicle departs from the location. In other words, a location visit captures a subsequence of requests at a given location. The start time of a visit is the arrival time at the first request in the visit, and the end time is the departure time at the last request in the visit. The visits are transmitted as data to the subproblem but the arrival and departure times of the visits are variables.

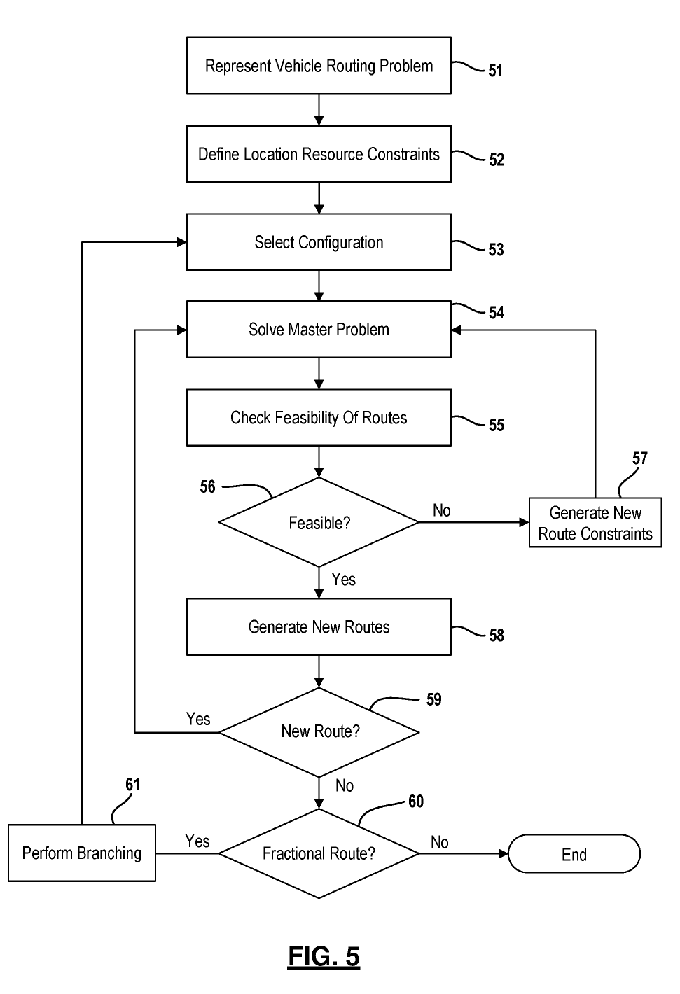

The visits require additional data and decision variables, which are listed in Table 3. The constraints of the subproblem are shown in FIG. 4. Constraints (33-36) are the time constraints. Constraints (37-38) link the start and end times of a visit to the arrival and departure times at the first and last requests of the visit. Constraint (39) calculates the duration of a visit and Constraint (40) is the cumulative resource constraint. Unlike for service resources, the durations of the visits are variables.

TABLE 3
Additional Data and Decision Variables for Visits
in the Separation Subproblem For Presence Resources

| Name | Description |
|---|---|
| [symbol] | Set of visits. |
| l(k) ∈ [symbol] | Location of visit k ∈ [symbol] . |
| [symbol] ₗ = {k ∈ [symbol] : l(k) = l} | Set of visits to location l ∈ [symbol] . |
| first(k) ∈ [symbol] | First request of the visit k ∈ [symbol] . |
| last(k) ∈ [symbol] | Last request of the visit k ∈ [symbol] . |
| start(k) ∈ [symbol] | Start time of visit k ∈ [symbol] . |
| end(k) ∈ [symbol] | End time of visit k ∈ [symbol] . |
| dur(k) ∈ [symbol] | Duration time of visit k ∈ [symbol] . |

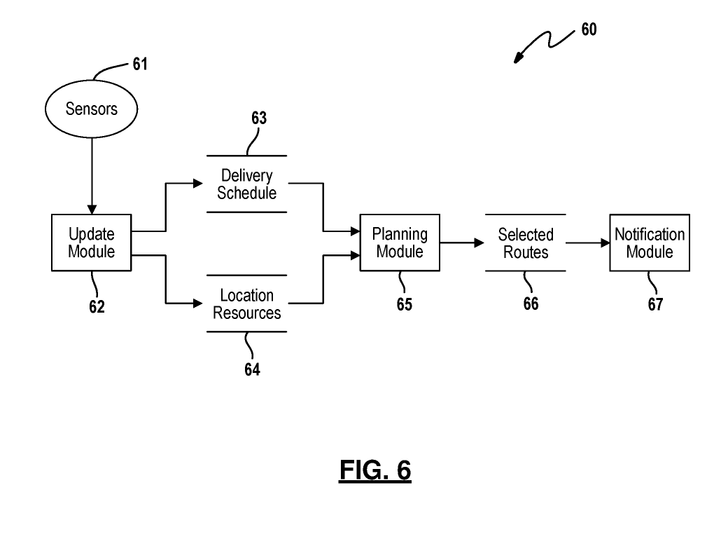

FIG. 5 depicts an example method for determining vehicle routing with location resource constraints. A set of routing requests serve as a starting point, such that each routing request specifies a start and end location for the request. From the set of routing requests, the vehicle routing problem is represented at 51 with a plurality of nodes arranged in a graph. The graph includes start nodes, end nodes and intermediary nodes, such that the intermediary nodes are locations that a vehicle stops at while traversing from a start node to an end node. Location resource constraints are also defined at 52 for the vehicle routing problem as described above. The location resource constraints specify temporal dependencies between vehicles caused by constraints on the availability of resources at locations visited by the vehicles.

An iterative algorithm begins by choosing an initial configuration to solve as indicated at 53. The configuration specifies a pool of possible routes for vehicle which encompasses all of the location in the set of routing requests. Two heuristics for choosing configurations from the graph are evaluated. In the first heuristic, the algorithm chooses nodes based on a depth-first heuristic until a solution is found, and then switches to a best-first heuristic, which selects the node with the smallest lower bound. In the second heuristic, the algorithm chooses configurations using a breadth-first heuristic, then switches to the best-first heuristic once a solution is found. Other techniques for choosing configurations are also contemplated by this disclosure.

For the chosen configuration, the algorithm first solves the master problem at step 54. That is, the algorithm selects a subset of routes from the pool in accordance with certain constraints. In the example embodiment, the subset of routes are determined using a linear programming method, such that a number a number between zero and one is assigned to each route in the pool of possible routes. The assignment is made to ensure that each routing request in the set of routing requests is served while minimizing a cost function, where on example of a cost function evaluates total travel distance. Also, the assignment is made subject to a set of route constraints as further described below. On the contrary, the assignment of the subset of routes is made without regard to the location resource constraints. In one embodiment, the algorithm solves the separation problem for each integer route (i.e., xᵣ=1). In other embodiments, the algorithm counts the number of integer routes, i.e., routes r with xᵣ=1. If there are at least min_{l∈L} Cₗ; integer routes, the algorithm solves the separation subproblem on these routes. It is unnecessary to solve the separation subproblem if there are fewer than c integer xᵣ variables as the location constraints are automatically satisfied. Note that the solution to the master problem may consist of fractional values for some routes, but only the integer routes are transferred to the separation subproblem.

The separation subproblem checks feasibility of the integer routes with regard to the location resource constraints. In one embodiment, the feasibility check is performed at 55, for example using a constraint programming method. If no feasible schedule exists for these routes, a nogood cut is generated at 57 and added to the master problem, which is reoptimized. Otherwise, if all routes are integral, then the routes and the schedules form a solution. Since the algorithm may iterate through this step multiple times for a configuration, it is possible, though unlikely, that multiple solutions are found within the open configuration.

The algorithm then proceeds to the pricing subproblem. The pricing subproblem generates routes at 58 to add to the pool of available routes. In one embodiment, new routes are generated by solving an elementary resource-constrained shortest path problem, for example using a labeling algorithm. If new routes are found, the new routes are added to the master problem, which is reoptimized. The process is then repeated. When no new routes are found, processing for the open configuration is complete. Branching occurs if any route in the master problem is fractional, and the lower bound of the configuration is lower than the incumbent solution as indicated at step 60. In one example, the algorithm selects a fractional route r′=i₁, i₂, . . . iₙ₋₁, iₙ) of length n, and creates n children, in which certain arcs must or must not be used. Each child corresponds to a prefix (i₁, i₂, . . . , iⱼ) in which the edges (i₁, i₂, . . . , iⱼ₋₁, iⱼ) must be present and the edge (iⱼ, iⱼ₊₁) must be absent. This branching scheme is easily implemented by restricting the successor matrix. Similar branching rules have previously appeared in the literature. The children configurations are added to the set of open configurations. In this way, the one or more child configurations are obtained by enforcing use of certain edges in the graph and precluding use of certain edges in the graph. Another configuration is select and steps above are repeated as indicated at 53. This process is repeated until until all of the routes in the pool of possible routes are integer routes. Note that the pricing algorithm may be terminated early to avoid the tailing-off effect that prevents convergence. In this case, the lower bound can be computed using the dual variables and reduced costs.

Experimental results for the constraint programming (CP) and branch-and-price-and check (BPC) approaches are described. A set of hard random instances are created by independently generating five locations and 150 pickup and delivery requests, and then distributing these requests among the locations. Smaller instances are created by discarding some of the requests. Resource capacities between one and eight are tested for all instances.

For testing purposes, the CP model is solved using C_{HUFFED}, a state-of-the-art CP solver with nogood learning. The solver first branches on the successor variables and then on the time variables. The master problem of the BPC model is solved using G_{UROBI}. The pricing subproblem is solved using a bespoke implementation of a labeling algorithm, and the separation subproblem is solved using C_{HUFFED}. The three problems within the BPC model are embedded in the search algorithm discussed above. Both the CP and BPC models are run for two hours.

Table 4 displays the results for service resources. The main findings are summarized as follows.
1. The pure CP model finds optimal solutions to the instances with 10 pickup-delivery requests but fails to find any feasible solution to the larger instances.
2. The BPC model finds optimal solutions to all feasible instances with 10 and 20 requests and some of the feasible instances with 40 requests.
3. For instances with 40 or more requests and resource capacities of 1, the CP model proves infeasibility. This is due stronger reasoning by the cumulative constraint in the CP model. The BPC model repeatedly iterates between the master and separation problems, and cannot prove infeasibility.
4. The BPC solutions to the instances with 80 or fewer requests improve as the resource capacities increase and the resource constraints relax. This is no longer the case for problems with 100 or more requests (given the time limit). This is mainly due to the nogood cuts which influence the dual variables and lead the pricing subproblem to generate different routes.
5. For the larger instances with low resource capacity, neither a feasible solution nor a proof of infeasibility is found by either method.
6. For the given time limit, the optimality gap is typically under 5% whenever the BPC model finds a feasible solution.
7. For most instances, the depth-first-then-best-first search finds more and better solutions than other search strategies, including depth-first, breadth-first, and best-first search. These results are not shown in this disclosure.

Table 5 shows the results for the instances with presence resources. Some remarks are below:
1. Unlike for service resources, the CP model is unable to prove infeasibility for any of the instances. This is due to weaker propagation of the cumulative constraint since the visit durations are now variable. It may be beneficial to add the service resources cumulative constraint as a redundant constraint since, as previously discussed, the service resources are fully contained in the presence resources.
2. For the problem with 150 requests, the optimality gap of the BPC model is tighter for presence resources than for service resources.

The BPC model exploits the orthogonal strengths of mathematical programming and constraint programming, using column generation to provide routes and dual bounds, and CP to check the feasibility of the scheduling constraints. These results indicate that the BPC model outperforms the CP model on all instances besides those with service resource capacities of 1. On these few instances, the problem is disjunctive and the activities have fixed duration, allowing the CP model to make strong deductions about the feasibility of resource schedules.

TABLE 4
Solutions from the two models for service resources. The first two
columns report the number of pickups, and the resource capacity of each
location. For the CP model, the three columns show the best solution, its solution
time, and the exit time of the solver, which is the time when the solver proves
optimality or infeasibility. For the BPC model, the four columns show the best
solution, its solution time, the optimality gap at exit, and the exit time. Instances
with higher resource capacity than those shown are omitted if increasing the
resource capacity does not improve the objective value.

| | | CP | | | BPC Depth-Best | | | | BPC Breadth-Best | | | |
|---|---|---|---|---|---|---|---|---|---|---|---|---|
| P | Cᵢ | Obj | Time | ET | Obj | Time | Gap | ET | Obj | Time | Gap | ET |
| 10 | 1 | 479 | 11 | 18 | 479 | 1 | 0.0% | 1 | 479 | 0 | 0.0% | 0 |
| | 2 | 479 | 10 | 18 | 479 | 1 | 0.0% | 1 | 479 | 0 | 0.0% | 0 |
| 20 | 1 | — | — | — | 811 | 7062 | 2.5% | — | 811 | 22 | 0.0% | 315 |
| | 2 | — | — | — | 771 | 1 | 0.0% | 1 | 771 | 0 | 0.0% | 0 |
| | 3 | — | — | — | 771 | 1 | 0.0% | 1 | 771 | 0 | 0.0% | 0 |
| 40 | 1 | — | — | 363 | — | — | — | — | — | — | — | — |
| | 2 | — | — | — | 1190 | 2244 | 2.2% | — | 1171 | 3428 | 0.8% | — |
| | 3 | — | — | — | 1162 | 3 | 0.0% | 43 | 1162 | 2 | 0.0% | 30 |
| | 4 | — | — | — | 1162 | 3 | 0.0% | 42 | 1162 | 2 | 0.0% | 30 |
| 60 | 1 | — | — | 2 | — | — | — | — | — | — | — | — |
| | 2 | — | — | — | — | — | — | — | — | — | — | — |
| | 3 | — | — | — | 1683 | 9 | 4.5% | — | 1700 | 6687 | 6.1% | — |
| | 4 | — | — | — | 1620 | 3576 | 1.2% | — | 1629 | 4836 | 1.2% | — |
| | 5 | — | — | — | 1625 | 5681 | 0.6% | — | 1625 | 6855 | 0.6% | — |
| | 6 | — | — | — | 1625 | 5316 | 0.6% | — | 1625 | 6848 | 0.6% | — |
| 80 | 1 | — | — | 0 | — | — | — | — | — | — | — | — |
| | 2 | — | — | — | — | — | — | — | — | — | — | — |
| | 3 | — | — | — | — | — | — | — | — | — | — | — |
| | 4 | — | — | — | 2096 | 126 | 7.3% | — | — | — | — | — |
| | 5 | — | — | — | 1955 | 3223 | 0.2% | — | 1955 | 4313 | 0.2% | — |
| | 6 | — | — | — | 1955 | 904 | 0.1% | — | 1955 | 1000 | 0.0% | 4293 |
| 100 | 1 | — | — | 0 | — | — | — | — | — | — | — | — |
| | 2 | — | — | — | — | — | — | — | — | — | — | — |
| | 3 | — | — | — | — | — | — | — | — | — | — | — |
| | 4 | — | — | — | 2495 | 106 | 9.2% | — | — | — | — | — |
| | 5 | — | — | — | 2362 | 59 | 3.8% | — | — | — | — | — |
| | 6 | — | — | — | 2319 | 43 | 2.0% | — | 2292 | 5322 | 0.9% | — |
| | 7 | — | — | — | 2386 | 68 | 4.7% | — | 2299 | 5039 | 1.1% | — |
| | 8 | — | — | — | 2300 | 6222 | 1.1% | — | 2315 | 3792 | 1.8% | — |
| 150 | 1 | — | — | 1 | — | — | — | — | — | — | — | — |
| | 2 | — | — | — | — | — | — | — | — | — | — | — |
| | 3 | — | — | — | — | — | — | — | — | — | — | — |
| | 4 | — | — | — | — | — | — | — | — | — | — | — |
| | 5 | — | — | — | — | — | — | — | — | — | — | — |
| | 6 | — | — | — | 3354 | 362 | 100.0% | — | — | — | — | — |
| | 7 | — | — | — | — | — | — | — | — | — | — | — |
| | 8 | — | — | — | 3300 | 188 | 100.0% | — | — | — | — | — |

TABLE 5
Solutions from the two models for presence resources. Instances
with low resource capacity are omitted from this table if neither a feasible solution
nor a proof of infeasibility is found. Instances with higher resource capacity than
those shown are also omitted if increasing the resource capacity does not
improve the objective value.

| | | CP | | | BPC Depth-Best | | | | BPC Breadth-Best | | | |
|---|---|---|---|---|---|---|---|---|---|---|---|---|
| P | Cᵢ | Obj | Time | ET | Obj | Time | Gap | ET | Obj | Time | Gap | ET |
| 10 | 1 | 479 | 11 | 19 | 479 | 0 | 0.0% | 0 | 479 | 0 | 0.0% | 0 |
| | 2 | 479 | 11 | 18 | 479 | 0 | 0.0% | 0 | 479 | 0 | 0.0% | 0 |
| 20 | 2 | — | — | — | 771 | 0 | 0.0% | 1 | 771 | 0 | 0.0% | 0 |
| | 3 | — | — | — | 771 | 0 | 0.0% | 1 | 771 | 0 | 0.0% | 0 |
| 40 | 2 | — | — | — | 4473 | 1873 | 74.5% | — | — | — | — | — |
| | 3 | — | — | — | 1162 | 2 | 0.0% | 49 | 1162 | 2 | 0.0% | 36 |
| | 4 | — | — | — | 1162 | 2 | 0.0% | 40 | 1162 | 2 | 0.0% | 33 |
| 60 | 3 | — | — | — | 1799 | 1286 | 11.6% | — | — | — | — | — |
| | 4 | — | — | — | 1629 | 3477 | 1.2% | — | 1629 | 4881 | 1.2% | — |
| | 5 | — | — | — | 1625 | 5378 | 0.6% | — | 1629 | 6680 | 0.9% | — |
| | 6 | — | — | — | 1625 | 5030 | 0.6% | — | 1625 | 6813 | 0.6% | — |
| | 7 | — | — | — | 1625 | 4761 | 0.6% | — | 1625 | 5992 | 0.6% | — |
| 80 | 5 | — | — | — | 2009 | 1171 | 3.2% | — | — | — | — | — |
| | 6 | — | — | — | — | — | — | — | 1955 | 2232 | 0.1% | — |
| | 7 | — | — | — | 1955 | 793 | 0.0% | 4339 | 1955 | 1256 | 0.0% | 5391 |
| | 8 | — | — | — | 1955 | 1021 | 0.1% | — | 1955 | 1197 | 0.0% | 5230 |
| 100 | 6 | — | — | — | 2299 | 5141 | 1.1% | — | 2315 | 831 | 1.8% | — |
| | 7 | — | — | — | 2316 | 68 | 1.9% | — | — | — | — | — |
| | 8 | — | — | — | 2299 | 4210 | 1.1% | — | — | — | — | — |
| 150 | 7 | — | — | — | 3267 | 182 | 6.4% | — | — | — | — | — |
| | 8 | — | — | — | 3240 | 187 | 5.5% | — | — | — | — | — |

This disclosure develops the Vehicle Routing Problem with Location Resource Constraints, which overlays a Resource-Constrained Project Scheduling Problem on a traditional Vehicle Routing Problem. Two types of location resources are considered: service resources are used while requests are in service, and presence resources are used whenever a vehicle is present at a location. Other types of location resources are also contemplated by this disclosure. The problem is formulated as a constraint programming model and a branch-and-price-and-check (BPC) model. In the BPC model, the pricing subproblem generates routes for the master problem, and the separation subproblem checks the routes selected by the master problem for feasibility of the resource scheduling constraints.

Empirical results indicate that the BPC model finds feasible solutions to instances with up to 150 pickup-delivery requests and proves optimality on instances with up to 80 pickup-delivery requests. It outperforms the constraint programming model, which is unable to scale to instances larger than 10 pickup-delivery requests. These results highlight the benefits of integrating the unique strengths of mathematical programming and constraint programming.

FIG. 6 depicts an example vehicle routing system 60. The system is comprised of an update module 62, a planning module 65 and a notification module 67. As used herein, the term module may refer to, be part of, or include an Application Specific Integrated Circuit (ASIC), an electronic circuit, a processor (shared, dedicated, or group) and/or (shared, dedicated or group) that execute one or more software or firmware programs, a combinational logic circuit, and/or other suitable components that provide the described functionality.

In an example embodiment, the planning module 55 receives a delivery schedule for a fleet of vehicles, such as delivery truck or planes. The delivery schedule 63 includes a listing of available vehicles, a listing of delivery sites, including a starting location, an ending location and any intermediate delivery locations, and time windows for reaching each of the locations. The delivery schedule may include other information (e.g., attributes for each vehicle). In addition, the planning module 65 is configured to receive information about the delivery locations, including available resources associated with the location. For example, location resource information may include a number of fueling stations or a number of airport terminals.

The planning module 65 determines vehicle routing, for example in accordance with the method set forth in FIG. 5. The output of the planning module 65 is a set of selected routes for vehicles which fulfills the delivery schedule within the bounds of the location resource constraints. The selected routes may include an arrival time and a departure time for each location.

Vehicles are in turn schedule according to the listing of selected routes. For example, the list of selected routes may be used by a dispatcher to schedule drivers and truck deliveries or used by an air traffic controller to route airplanes. The notification module 67 is configured to receive the set of selected routes from the planning module 65. The notification module in turn operates to send notifications to persons of interest, such as individual truck drivers. In one embodiment, the notification is a text message or an email message. Other forms of notification are also contemplated by this disclosure.

In some embodiments, the vehicle routing system 60 may receive data in real-time during execution of the delivery schedule. Specifically, the update module 62 is configured to receive data from one or more sensors. For example, the update module 62 may receive GPS coordinates from a particular vehicle along its route. In another example, the update module 62 may receive an arrival or departure time of a particular vehicle from a location. The update module 62 may in turn update the delivery schedule and/or location resource data based on the real-time data. Moreover, depending upon the nature of the updates, the update module 62 may trigger the planning module 65 to recalculate the routes based on the updated information.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for determining vehicle routing with location resource constraints, comprising:
receiving a set of routing requests, where each routing request in the set of routing requests specifies a start location for a vehicle and an end location for the vehicle;
representing a vehicle routing problem with a plurality of nodes arranged in a graph, where the graph includes start nodes, end nodes and intermediary nodes, such that the intermediary nodes are locations that a vehicle stops at while traversing from a start node to an end node;
defining location resource constraints for the vehicle routing problem, where location resource constraints specify temporal dependencies between vehicles caused by constraints on the availability of resources at locations visited by the vehicles along a route;
generating a configuration from the graph, where the configuration specifies a pool of possible routes for vehicles and encompasses the locations specified in the set of routing requests;
a) for the configuration, assigning a number between zero and one to each route in the pool of possible routes, where the assignment ensures that each routing request in the set of routing requests is served, minimizes a cost function and is subject to a set of route constraints;
b) identifying routes in the pool of possible routes assigned a value of one;
c) checking feasibility of the identified routes with regard to the location resource constraints;
d) generating a new route constraint, adding the new route constraint to the set of route constraints and repeating step a)-d) as long as the identified routes are not feasible;
e) generating new routes for the pool of available routes and repeating steps a)-e) as long as one or more new routes for the pool of available routes are generated, where the new routes decrease value of the cost function obtained in step a;
f) generating a new configuration from the graph and repeating steps a)-f) until all of the routes in the pool of possible routes has a value of one, where the new configuration is obtained by enforcing use of certain edges in the graph and precluding use of certain edges in the graph.

2. The method of claim 1 wherein the location resource constraints limit the number of vehicles present at a given location, where the presence of a vehicle is specified by the interval between an arrival time and a departure time.

3. The method of claim 1 wherein the location resource constraints limit the number of vehicles being served at the same time, where start of service time at a given location plus service duration is less than departure time from the given location and departure time from a given location plus the travel time to a successor node equals arrival time at the successor node.

4. The method of claim 1 wherein the location resource constraint includes a scheduling constraint modeled using CUMULATIVE(s, d, r, C) global constraint, where s, d and r are vectors that represent the start time, duration and resource requirement, respectively, of each activity and C is capacity of the resource.

5. The method of claim 1 wherein assigning a number further comprises using a linear programming method.

6. The method of claim 1 further comprises receiving a number of vehicles available for the set of routing requests; and assigning a number between zero and one subject to the number of available vehicles.

7. The method of claim 1 further comprises checking feasibility of the subset of routes using a constraint programming method.

8. The method of claim 1 further comprises generating new routes for the pool of available routes by solving a shortest path problem using a labeling algorithm.

9. The method of claim 1 wherein the new route constraint prohibits the same assignment to the routes when repeating steps a)-d).

10. The method of claim 1 wherein generating a new configuration further comprises identifying at least one fractional route in the subset of routes and creating n child configurations, each representing the selection of a prefix of the edges in the route and the exclusion of edges after the prefix.
